(19) United States
(12) Patent Application Publication
(10) Pub. No.: US 2024/0120189 A1
(43) Pub. Date: Apr. 11, 2024

(54) METHOD FOR ANALYZING DATA ACQUIRED BY MALDI MASS SPECTROMETRY, DATA-PROCESSING DEVICE, MASS SPECTROMETER, AND DATA-ANALYZING PROGRAM

(71) Applicant: SHIMADZU CORPORATION, Kyoto-shi (JP)

(72) Inventor: Kanae TERAMOTO, Kyoto-shi (JP)

(73) Assignee: SHIMADZU CORPORATION, Kyoto-shi (JP)

(21) Appl. No.: 17/960,609

(22) Filed: Oct. 5, 2022

(51) Int. Cl. H01J 49/16; H01J 49/00; H01J 49/40

(52) U.S. Cl. CPC H01J 49/164; H01J 49/0036; H01J 49/40

(57) ABSTRACT

A method for analyzing MALDI mass spectrometry data includes: calculating m/z values respectively corresponding to peaks in amass spectrum, from data corresponding to the mass spectrum acquired by MALDI mass spectrometry performed on a sample; and performing at least one of calculations (a) and (b), based on the m/z values and information on kinds of ions possibly generated from the sample in the mass spectrometry, where calculation (a) includes assuming that ions respectively corresponding to the peaks are first ions singly charged, and calculating m/z of second ions respectively corresponding to the first ions and being multiply charged, and calculation (b) includes assuming that ions respectively corresponding to the peaks are first ions that are multiply charged ions, and calculating m/z of second ions respectively corresponding to the first ions and being singly charged.

### TECHNICAL FIELD

The present invention relates to a method for analyzing data acquired by MALDI mass spectrometry, data-processing device, mass spectrometer, and data-analyzing program.

### BACKGROUND ART

Mass spectrometric analyses in which a sample is ionized by matrix assisted laser desorption/ionization (MALDI) have been commonly performed. This type of mass spectrometry is hereinafter appropriately called the “MALDI mass spectrometry”. In MALDI, singly charged ions are most likely to be generated, so that easy-to-analyze mass spectra can be acquired. By comparison, in electrospray ionization (ESI), multiply charged ions are easily generated. A mass spectrometric analysis employing ESI includes determining whether or not a given peak in a mass spectrum has originated from a multiply charged ion (see Patent Literature 1).

### CITATION LIST

### Patent Literature

Patent Literature 1: JP 2016-57219 A

### SUMMARY OF INVENTION

### Technical Problem

Even when MALDI is used for ionization, an ion having the number of charges equal to or greater than two may possibly be generated. In that case, if a data analysis is performed on the assumption that all ions are singly charged ions, an incorrect analysis result will be obtained.

### Solution to Problem

The first aspect of the present invention relates to a method for analyzing mass spectrum data acquired by matrix assisted laser desorption/ionization (MALDI) mass spectrometry, including:
calculating a plurality of m/z values each of which corresponds to each of a plurality of peaks in a mass spectrum, from data corresponding to the mass spectrum acquired by a mass spectrometric analysis including MALDI performed on a sample; and
performing at least one of two calculations (a) and (b), based on the plurality of m/z values and information on kinds of ions having a possibility of being generated from the sample in the mass spectrometric analysis, where
   the calculation (a) includes assuming that a plurality of ions each of which corresponds to each of the plurality of peaks are first ions that are singly charged ions, and calculating m/z values of second ions respectively corresponding to the first ions and being multiply charged ions, and
   the calculation (b) includes assuming that a plurality of ions each of which corresponds to each of the plurality of peaks are first ions that are multiply charged ions, and calculating m/z values of second ions respectively corresponding to the first ions and being singly charged ions.

The second aspect of the present invention relates to a data processing device including:
a first calculator configured to calculate a plurality of m/z values each of which corresponds to each of a plurality of peaks in a mass spectrum, from data corresponding to the mass spectrum acquired by a mass spectrometric analysis including matrix assisted laser desorption/ionization (MALDI) performed on a sample; and
a second calculator configured to perform at least one of two calculations (a) and (b), based on the plurality of m/z values and information on kinds of ions having a possibility of being generated from the sample in the mass spectrometric analysis, where
   the calculation (a) includes assuming that a plurality of ions each of which corresponds to each of the plurality of peaks are first ions that are singly charged ions, and calculating m/z values of second ions respectively corresponding to the first ions and being multiply charged ions, and
   the calculation (b) includes assuming that a plurality of ions each of which corresponds to each of the plurality of peaks are first ions that are multiply charged ions, and calculating m/z values of second ions respectively corresponding to the first ions and being singly charged ions.

The third aspect of the present invention relates to a mass spectrometer including:
a data processing device according to the second aspect; and
an ionizer section for matrix assisted laser desorption ionization (MALDI).

The fourth aspect of the present invention relates to a data-analyzing program for making a computer perform:
a first calculation process which includes calculating a plurality of m/z values each of which corresponds to each of a plurality of peaks in a mass spectrum, from data corresponding to the mass spectrum acquired by a mass spectrometric analysis including matrix assisted laser desorption/ionization (MALDI) performed on a sample; and
a second calculation process which includes performing at least one of two calculations (a) and (b), based on the plurality of m/z values and information on kinds of ions having a possibility of being generated from the sample in the mass spectrometric analysis, where
   the calculation (a) includes assuming that a plurality of ions each of which corresponds to each of the plurality of peaks are first ions that are singly charged ions, and calculating m/z values of second ions respectively corresponding to the first ions and being multiply charged ions, and
   the calculation (b) includes assuming that a plurality of ions each of which corresponds to each of the plurality of peaks are first ions that are multiply charged ions, and calculating m/z values of second ions respectively corresponding to the first ions and being singly charged ions.

### Advantageous Effects of Invention

According to the present invention, a correct data analysis can be performed even when an ion having the number of charges equal to or greater than two has been generated by MALDI.

### BRIEF DESCRIPTION OF DRAWINGS

FIG. 1 is a conceptual diagram for explaining a method for analyzing data acquired by MALDI mass spectrometry according to one embodiment.

FIG. 2 is a conceptual diagram for explaining a method for analyzing data acquired by MALDI mass spectrometry according to one embodiment.

FIG. 3 is a conceptual diagram for explaining the calculation of a degree of similarity.

FIG. 4 is a conceptual diagram showing the configuration of a mass spectrometer according to one embodiment.

FIG. 5 is a conceptual diagram showing the configuration of an information processing unit in the mass spectrometer.

FIG. 6 is a flowchart showing the process steps of a method for analyzing data acquired by MALDI mass spectrometry according to one embodiment.

FIG. 7 is a conceptual diagram for explaining a method for analyzing data acquired by MALDI mass spectrometry according to a modified example.

FIG. 8 is a conceptual diagram for explaining a method for analyzing data acquired by MALDI mass spectrometry according to a modified example.

FIG. 9 is a conceptual diagram for explaining a method for analyzing data acquired by MALDI mass spectrometry according to a modified example.

FIG. 10 is a conceptual diagram for explaining how to provide a program.

FIG. 11 is a diagram showing a mass spectrum acquired in an example.

FIG. 12 is a table showing measured values of the m/z and peak intensity of a singly charged ion, measured values of the m/z and peak intensity of a doubly charged ion, as well as the ratio of the intensity of the singly charged ion to that of the doubly charged ion, for each of the ribosomal proteins extracted by the data analysis in an example.

### DESCRIPTION OF EMBODIMENTS

An embodiment of the present invention is hereinafter described with reference to the drawings.

### Embodiment

The following description of the present embodiment deals with a method for analyzing data acquired by a mass spectrometric analysis in which matrix accosted laser desorption/ionization (MALDI) is used to ionize a sample (MALDI mass spectrometry).

(Sample)

There is no specific limitation on the sample as long as the molecules contained in the sample can be ionized by MALDI. MALDI mass spectrometry does not require complex operations and allows for quick identification of microorganisms. From this point of view, a sample which definitely or potentially contains a microorganism is preferable.

When the sample contains a microorganism, the sample can be prepared by collecting a colony or culture solution obtained by culture, adding a matrix-containing solution (which is hereinafter called the “matrix solution”) to the colony or the fungi in the culture solution, dropping the solution onto a sample plate for MALDI, and drying the solution. It is also possible to place fungi on a sample plate for MALDI and add the matrix solution. Although there is no specific limitation on the kind of matrix, some matrices are preferable for performing mass spectrometry with a high level of accuracy, such as CHCA (α-cyano-4-hydroxycinnamic acid), sinapinic acid or DHB (2,5-dihydroxybenzoic acid). As for the solvent of the matrix solution, an aqueous solution containing an organic solvent, such as acetonitrile, by tens of percent by volume, with trifluoroacetic acid (TFA) added by 0-3 percent by volume, can be used, for example.

Another possible method for preparing a sample is to extract a component to be analyzed from fungi obtained by culture and add the matrix solution to the extract. An additive to the matrix may be appropriately used in the preparation of the sample. Similarly, for the preparation of a sample from a target which is not a microorganism, commonly known methods for pretreatments or other related tasks can be appropriately used.

(Mass Spectrometry)

In the mass spectrometric method according to the present embodiment, there is no specific limitation on the kind of mass spectrometry as long as the ions originating from a sample subjected to MALDI can be mass-separated and a set of data corresponding to a mass spectrum can be acquired with a desired level of accuracy. The “data corresponding to a mass spectrum” is a set of data in which the m/z values of the ions detected by mass spectrometry and the intensities of the detection signals of those ions are related to each other. This type of data is hereinafter called the “mass spectrum data”. For example, a quadrupole, ion trap, or time-of-flight type of mass spectrometry can be performed in the mass spectrometric method according to the present embodiment. Among those examples, the time-of-flight mass spectrometry is preferable from the viewpoint that it can achieve accurate mass separation of high-mass molecules exceeding thousands of Daltons. The description of the following embodiment deals with an example of analyzing mass spectrum data acquired through single-stage mass spectrometry.

(Data Analysis)

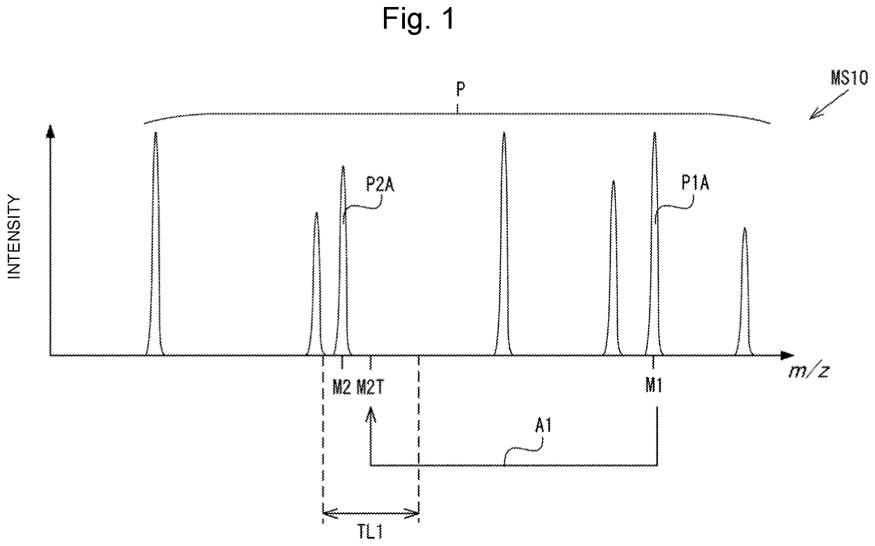

FIG. 1 is a conceptual diagram for explaining a method for analyzing data acquired by MALDI mass spectrometry according to the present embodiment. In FIG. 1, a mass spectrum MS10 corresponding to a set of mass spectrum data acquired by MALDI mass spectrometry is shown. It should be noted that a “mass spectrum” in the following embodiment and the drawings is a graph with the horizontal axis indicating the m/z value of each ion detected by mass spectrometry and the vertical axis indicating the intensity of the detection signal of the ion.

In the mass spectrum MS10, a plurality of peaks P corresponding to the detected ions are shown. In MALDI mass spectrometry, singly charged ions are most likely to be generated. However, in some cases, an ion having the number of charges equal to or greater than two is also detected. In the following embodiment, an ion having the number of charges equal to or greater than two is called a “multiply charged ion”. In the present embodiment, whether or not a peak corresponds to a singly charged ion is determined for each peak in the mass spectrum MS10. This determination is hereinafter called the “charge-number determination”. Strictly speaking, there may be the case in which it is more appropriate for the charge-number determination to be described as the determination of whether or not the peak concerned should be treated as a peak corresponding to a singly charged ion. Including this case, the charge-number determination is performed to determine, for each peak in the mass spectrum MS10, whether or not the peak corresponds to a singly charged ion.

In the charge-number determination, at least one of the following calculations (a) and (b) is performed:
(a) For each of the peaks in the mass spectrum MS10, the ion corresponding to the peak concerned is assumed to be a singly charged ion, and the m/z value of a multiply charged ion corresponding to that singly charged ion is calculated.
(b) For each of the peaks in the mass spectrum MS10, the ion corresponding to the peak concerned is assumed to be a multiply charged ion, and the m/z value of a singly charged ion corresponding to that multiply charged ion is calculated.

In the following embodiment, that a singly charged ion and a multiply charged ion “correspond to” each other means that these two ions are produced from the same kind of molecule, and that the same kind of atom or atom group is bonded to the molecule in the process of the production of those ions. For example, in the case where protonated ions are produced from molecule X by MALDI, the singly charged ion is [X+H]⁺, and the multiply charged ion corresponding to this singly charged ion is [X+NH]^{N+}, where N is the number of charges (which is an integer equal to or greater than two). That an ion and a peak “correspond to” each other means that the detection signal at the time of the detection of the ion in a mass spectrometric analysis is represented by the peak in the mass spectrum.

In calculations (a) and (b), each of the ions which respectively correspond to the peaks in the mass spectrum MS10 is an ion which has been detected in a mass spectrometric analysis and is hereinafter called a “first ion”. Furthermore, the ion whose m/z value is calculated in calculations (a) and (b) is an ion which corresponds to the first ion, and that ion is hereinafter called the “second ion”. The m/z value calculated in calculations (a) and (b) is a theoretical value of the m/z value of the second ion based on the m/z value of the peak corresponding to the first ion.

In calculation (a), it is preferable to calculate the m/z value of a doubly charged ion and/or triply charged ion as the second ion. An ion having too large a number of charges is unlikely to be generated and will cause an incorrect charge-number determination. From a similar point of view, in calculation (b), it is preferable to calculate the m/z value of the second ion on the assumption that the first ion is a doubly charged ion and/or triply charged ion.

FIG. 1 is a conceptual diagram for explaining the method for the charge-number determination in the case of calculation (a). The peak P1A in the mass spectrum MS10 is assumed to be the peak corresponding to the first ion. M1 denotes the m/z value of the first ion, and M2T denotes the m/z value of the second ion which is a multiply charged ion corresponding to the first ion which is assumed to be a singly charged ion. The m/z value of the second ion is calculated based on the m/z value of the first ion and the kinds of ions which may possibly be produced in the mass spectrometry according to the present embodiment. The arrow A1 in FIG. 1 schematically shows the calculation of the m/z value of the second ion based on the m/z value of the first ion. For example, when the second ion is a doubly charged ion generated by protonation, then the m/z value of the second ion, M2T, can be calculated by the following equation (1):

M2T=(M1−MH)/2+MH (1)

where MH is the mass of the hydrogen atom in atomic mass units.

A more generalized explanation is as follows: Consider the case where the second ion is an ion whose number of charges is N (where N is an integer equal to or greater than two), and the first ion is a singly charged ion produced from molecule X by the addition of an atom or atom group A. In this case, the first ion is expressed as [X+A]⁺, while the second ion is expressed as [X+NA]^{N+}. The m/z value of the second ion, M2T, can be calculated by the following equation (2):

M2T=(M1−MA)N+MA (2)

where MA represents the mass of the atom or atom group in atomic mass units, and “/” means division.

In the charge-number determination, whether or not the peak corresponding to the m/z value of the first ion, or that of the detected second ion, is derived from a singly charged ion is determined based on whether or not a peak corresponding to the m/z value of the second ion is detected in the mass spectrum MS10.

When it is assumed that the peak PIA corresponds to the first ion which is singly charged, whether or not there is a peak corresponding to the m/z value M2T of the second ion having the number of charges equal to or greater than two is determined. For example, consider the case where a peak P2A whose m/z value M2 is within a first range TL1 including the m/z value M2T has been detected. In this case, it is determined that the ion corresponding to the peak P2A is not a singly charged ion, or that the ion should be handled as being a non-singly charged ion. In the following description, when it is determined that an ion which is the target of the charge-number determination is “not a singly charged ion”, it also implies that the ion “should be handled as a non-singly charged ion”. In practice, it is possible that an ion corresponding to an unrelated molecule has been detected by chance in the vicinity of the m/z value of a multiply charged ion corresponding to the peak P1A, and the ion corresponding to the peak P2A is actually a singly charged ion. However, handing the ion corresponding to the peak P2A as a non-singly charged ion is preferable in that an accurate analysis can be performed by using another peak which is more reliable.

When a peak P2A has been detected within the first range TL1, it is possible to determine that the first ion corresponding to the peak P1A is a singly charged ion, or its charge-number determination may be omitted.

The first range TL1 can be defined as a range corresponding to the so-called “mass tolerance”. It can be appropriately set based on the accuracy of the mass spectrometry. For example, the first range TL1 may be a range which is centered on the calculated m/z value of the second ion and covers an m/z range equal to or lower than 1%, 0.1% or 0.01% (or an even lower percentage) of the m/z value of the second ion.

The target peak of the charge-number determination may be selected based on its m/z value. In the case of calculation (a), a peak P falling within a range equal to or smaller than m/z 30000, or more preferably, equal to or smaller than m/z 20000, within which the m/z value can be accurately determined by time-of-flight mass spectrometry, can be selected as a peak corresponding to the first ion for the charge-number determination. In the case where the m/z value of the ion to be analyzed is previously known, as in the case of the identification of microorganisms, the target peak P of the charge-number determination may be set based on that m/z value. For example, consider the case of identifying a microorganism based on whether or not a peak corresponding to a ribosomal protein is detected. Among the ions of the ribosomal proteins which are most noticeably detected, the ion having the smallest m/z value is located around m/z 400. Therefore, when the charge-number determination is performed based on whether or not a peak corresponding to the doubly charged ion is present, the peak corresponding to the first ion for the charge-number determination may preferably be selected from a range equal to or greater than m/z 8000.

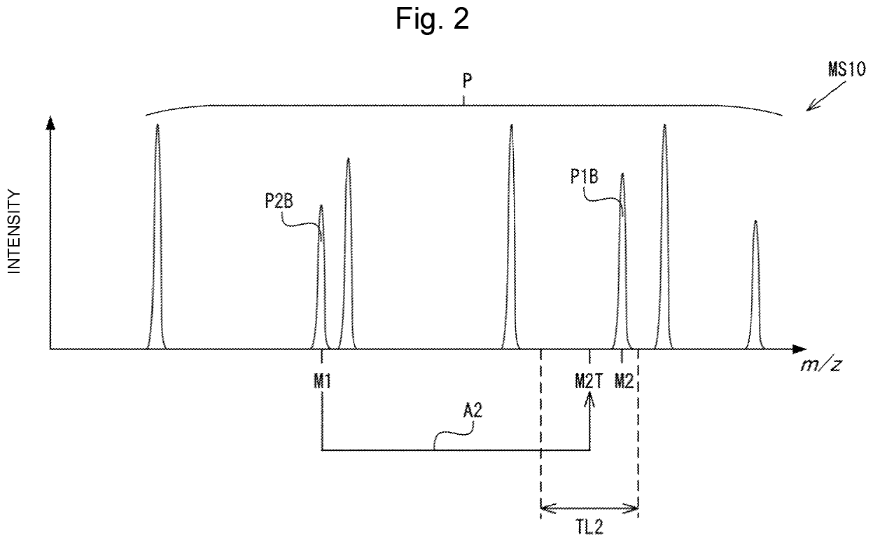

FIG. 2 is a conceptual diagram for explaining the method for the charge-number determination in the case of calculation (b). The peak P2B in the mass spectrum MS10 is assumed to be the peak corresponding to the first ion. M1 denotes the m/z value of the first ion, and M2T denotes the m/z value of the second ion which is a singly charged ion corresponding to the first ion which is assumed to be a multiply charged ion. The m/z value of the second ion is calculated based on the m/z value of the first ion and the kinds of ions which may possibly be produced in the mass spectrometry according to the present embodiment. The arrow A2 in FIG. 2 schematically shows the calculation of the m/z value of the second ion based on the m/z value of the first ion. For example, when the first ion is a doubly charged ion generated by protonation, then the m/z value of the second ion, M2T, can be calculated by the following equation (3):

M2T=(M1−MH)×2+MH (3)

where MH is the mass of the hydrogen atom in atomic mass units, and “x” means multiplication.

Similar to (a), a generalized explanation is given as follows: Consider the case where the second ion is an ion whose number of charges is N (where N is an integer equal to or greater than two), and the singly charged ion is produced from molecule X by the addition of an atom or atom group A. In this case, the first ion is expressed as [X+NA]⁺, while the second ion is expressed as [X+A]⁺. The m/z value of the second ion, M2T, can be calculated by the following equation (4):

M2T=(M1−MA)×N+MA (4)

where MA represents the mass of the atom or atom group in atomic mass units, and “x” means the product.

When it is assumed that the peak P2B corresponds to the first ion whose number or charges is equal to or greater than two, whether or not there is a peak corresponding to the m/z value M2T of the second ion which is singly charged is determined. For example, consider the case where a peak P1B whose m/z value M2 is within a second range TL2 including the m/z value M2T. In this case, it is determined that the first ion corresponding to the peak P2B is not a singly charged ion.

When a peak P2B has been detected within the second range TL2, it is possible to determine that the ion corresponding to the peak PIB is a singly charged ion, or its charge-number determination may be omitted.

The second range TL2 can be defined as a range corresponding to the so-called “mass tolerance”. It can be appropriately set based on the accuracy of the mass spectrometry. For example, the second range TL2 may be a range which is centered on the m/z value of the second ion and covers an m/z range equal to or lower than 1%, 0.1% or 0.01% (or an even lower percentage) of the m/z value of the second ion.

The target peak of the charge-number determination may be selected based on its m/z value. In the case of calculation (b), the charge-number determination can be performed so that a peak P falling within a range equal to or smaller than m/z 30000, or more preferably, equal to or smaller than m/z 20000, within which the m/z value can be accurately determined by time-of-flight mass spectrometry, corresponds to the second ion. For example, when the number of charges of the first ion is N, the charge-number determination can be performed so that a peak P whose m/z value falls within a range equal to or smaller than 30000/N, or more preferably, equal to or smaller than 20000/N corresponds to the first ion. In the case where the m/z value of the ion to be analyzed is previously known, as in the case of the microorganism identification, the target peak P of the charge-number determination may be set based on that m/z value. For example, consider the case of identifying a microorganism based on whether or not a peak corresponding to a ribosomal protein is detected. Among the ions of the ribosomal proteins which are most noticeably detected, the ion having the smallest m/z value is located around m/z 4000. Therefore, when the charge-number determination is performed on the assumption that the first ion is a doubly charged ion, the first ion for the charge-number determination may preferably be set within a range equal to or greater than m/z 2000.

In the following descriptions, a peak which has been concluded to be a peak corresponding to a multiply charged ion as a result of the charge-number determination is called a “multiply charged ion peak”, and a peak which has not been concluded to be a peak corresponding to a multiply charged ion is called a “singly charged ion peak”. Consider the situation in which at least one or some of the peaks P in the mass spectrum have been determined to be a multiply charged ion peak as a result of the charge-number determination. In that case, the multiply charged ion peaks can be discriminated from singly charged ion peaks in the analysis. The multiply charged ion peaks can be excluded from the analysis target, and the singly charged ion peaks can be selectively set as the target of the analysis of the mass spectrum data.

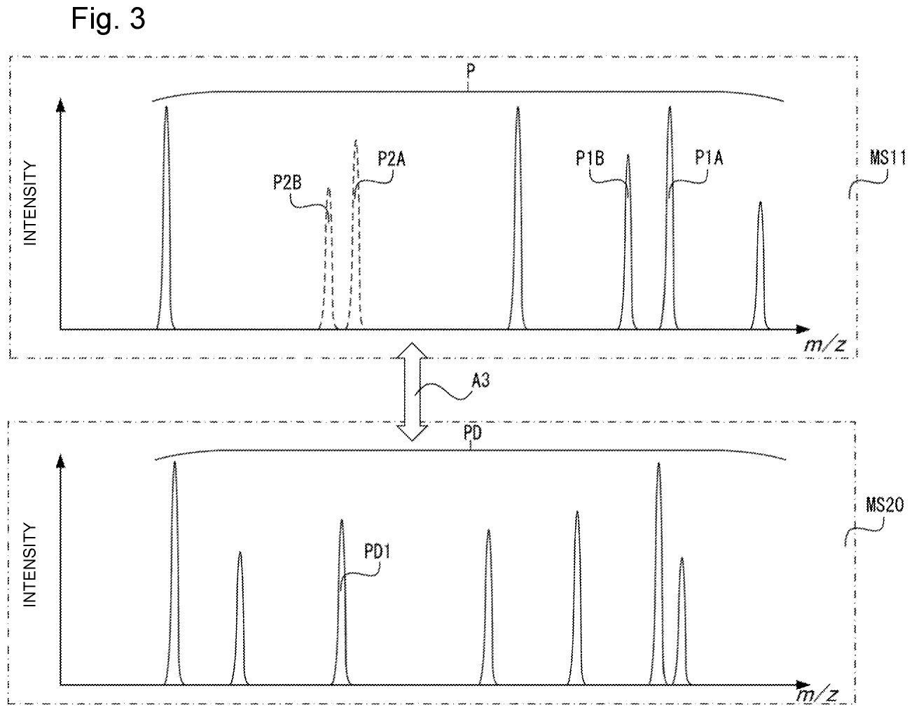

FIG. 3 is a conceptual diagram for explaining the method for analyzing mass spectrum data after the charge-number determination. The mass spectrum MS11 includes the same set of peaks P as the mass spectrum MS10, where a difference from the mass spectrum MS10 exists in that the multiply charged ion peaks P2A and P2B are indicated by broken lines. The peaks other than the multiply charged ion peaks P2A and P2B are assumed to be singly charged ion peaks.

The mass spectrum MS20 is a mass spectrum schematically showing singly charged ions corresponding to the molecules contained in a specific kind of microorganism. The microorganism identification is performed based on whether or not the peaks included in the mass spectrum MS11 of the measured sample correspond to the ions of the molecules contained in the microorganism. In the present embodiment, the microorganism contained in a sample is identified based on whether or not the peaks included in the mass spectrum MS11, exclusive of the multiply charged ion peaks P2A and P2B, correspond to the singly charged ions of the molecules contained in a microorganism. This is illustrated as the matching operation (arrow A3) for evaluating the degree of similarity between the pattern of the singly charged ion peaks in the mass spectrum MS11 and that of the peaks PD of the singly charged ions in the mass spectrum MS20.

The information concerning the molecules contained in a microorganism may preferably be related to the classification of the microorganism, such as the species or specific epithet, and stored in a database or similar storage medium beforehand. This information can include the m/z values of the ions corresponding to the molecules, calculated based on data of the genome of the microorganism or data of proteins which will be expressed in the microorganism. The m/z values may also be set from data acquired through a mass spectrometric analysis of the microorganism. In the latter case, the information concerning the molecules contained in a microorganism may preferably include the detection intensities of the peaks related to the m/z values. In this case, the microorganism can be identified with a higher level of accuracy by using the information of the detection intensities of the peaks. Here, the “detection intensity” means a value representing the magnitude of the detection signal corresponding to a peak, such as a peak intensity which is the maximum intensity of the peak, or a peak area of the peak.

There is no specific limitation on the method for the analysis of the mass spectrum data as long as the analysis is performed based on the information of the multiply charged ion peaks or singly charged ion peaks obtained by the charge-number determination. Exclusion of multiply charged ion peaks from the analysis target prevents the analysis from being inaccurate due to a peak which actually corresponds to a multiply charged ion and yet is assumed to be a singly charged ion in the analysis. In the example of FIG. 3, it is possible to prevent an analysis in which the singly charged ion corresponding to the peak PD1, contained in a predetermined microorganism, is incorrectly assumed to be an ion corresponding to a multiply charged ion peak P2A or P2B.

(Mass Spectrometer)

Hereinafter described is a mass spectrometer which can be suitably used for a method of mass spectrometry including a method for analyzing data acquired by the previously described MALDI mass spectrometry. The following description is concerned with the case of identifying a microorganism, although the method according to the present embodiment is also applicable in various tasks other than the microorganism identification.

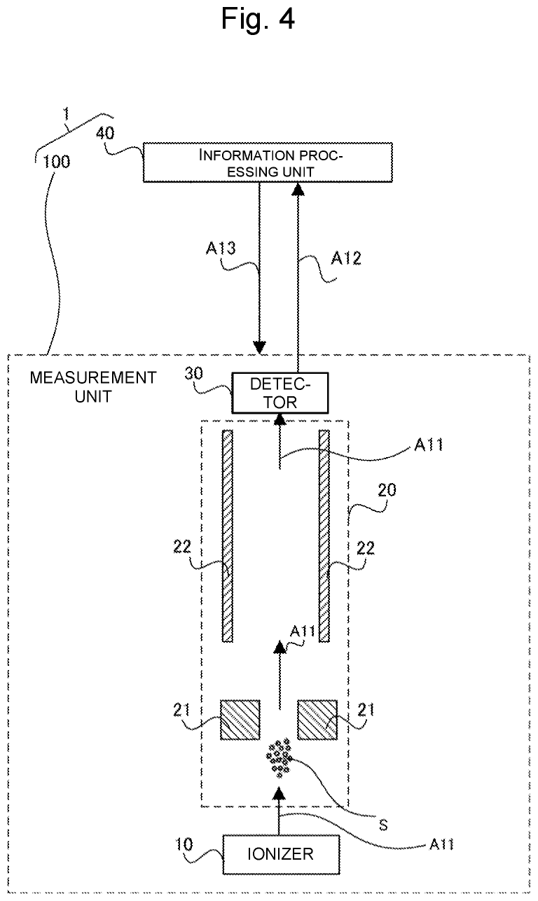

FIG. 4 is a conceptual diagram showing the configuration of a mass spectrometer 1. The mass spectrometer 1 includes a measurement unit 100 and an information processing unit 40. The information processing unit 40 serves as a data processing device.

The measurement unit 100 includes an ionizer section 10 for producing an ionized sample (which is hereinafter called “sample ions S”) by MALDI, a mass separator section 20, and a detector section 30. The mass separator section 20 includes an acceleration electrode 21 and a flight tube 22. In FIG. 4, the movement of the sample ions S is schematically indicated by the arrow A11.

The measurement unit 100 includes a mass spectrometer and is configured to ionize a sample and detect the resulting ions after mass separation.

The ionizer section 10 in the measurement unit 100 includes a sample plate holder (not shown) configured to support a sample plate for MALDI, and an ion source for MALDI including a laser device (not shown) configured to deliver a laser beam onto the sample plate for MALDI. The ionizer section 10 irradiates a sample with a laser beam to generate sample ions S. The sample ions S are appropriately converged by an ion lens or similar device (not shown) and introduced into the mass separator section 20.

The mass separator section 20 includes a time-of-flight mass analyzer. In the mass separator section 20, the sample ions S are accelerated by an acceleration electrode 21. The mass separator section 20 separates the sample ions S based on the fact that different kinds of sample ion S require different periods of time to fly through the flight tube 22 of the time-of-flight mass analyzer. The sample ions S separated from each other by mass by the mass separator section 20 enter the detector section 30.

The time-of-flight mass analyzer shown in FIG. 1 is a linear time-of-flight mass analyzer. This may be replaced by a reflectron, multiturn, or other types of time-of-flight mass analyzer. There is no specific limitation on the type of mass analyzer for constructing the mass separator section 20. An appropriate type of mass analyzer can be used according to the kind of mass spectrometry. The mass separator section 20 may include one or more desired types of mass analyzers, such as an ion trap or quadrupole mass filter.

The detector section 30 includes an ion detector, such as a microchannel plate, and is configured to detect sample ions S separated by the mass separator section 20. The detector section 30 produces a detection signal whose intensity corresponds to the amount of sample ions S falling onto the detector section 30 at each time of flight. The detection signals produced by the detector section 30 are converted from analogue to digital forms (A/D conversion) and stored in a storage section 43 in the information processing unit 40 as measurement data (arrow A12).

The information processing unit 40 includes an information processing device, such as a computer. The information processing unit 40 appropriately serves as an interface for a user of the mass spectrometer (who is hereinafter simply called the user) and performs the control of the measurement unit 100 as well as various processes related to data, such as the communication, storage and mathematical operations. The arrow A13 schematically shows the control of the measurement unit 100 by the information processing unit 40.

The information processing unit 40 may be integrated with the measurement unit 100 to form a single apparatus. A portion of the data to be used by the mass spectrometer 1 may be stored in a remote server or similar location.

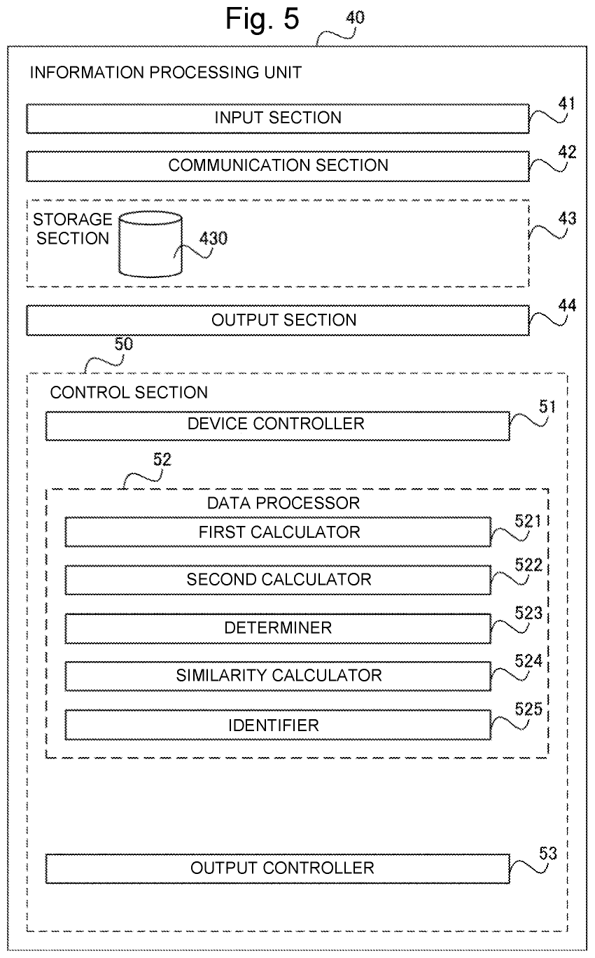

FIG. 5 is a conceptual diagram showing the configuration of the information processing unit 40. The information processing unit 40 includes an input section 41, communication section 42, storage section 43, output section 44 and control section 50. The storage section 43 includes a microorganism database (DB) 430. The control section 50 includes a device controller 51, data processor 52 and output controller 53. The data processor 52 includes a first calculator 521, second calculator 522, determiner 523, similarity calculator 524 and identifier 525.

The input section 41 in the information processing unit 40 includes an input device, such as a mouse, keyboard, buttons or touch panel. The input section 41 is configured to receive information from the user, such as information necessary for controlling an operation of the measurement unit 100 as well as information necessary for the processing performed by the control section 50.

The communication section 42 in the information processing unit 40 includes a communication device capable of wire or wireless communications through the Internet or similar networks. The communication section 42 appropriately transmits and receives necessary data.

The storage section 43 in the information processing unit 40 includes a non-volatile storage medium, in which analysis conditions, measurement data, programs for the control section 50 to execute processing, and other electronic contents are stored. In the microorganism database 430 stored in the storage section 43, the species or similar classification of a microorganism is related to the m/z, values of the ions of the molecules contained in the microorganism.

The output section 44 in the information processing unit 40 includes a display device, such as a liquid crystal display, a printer, or other types of output devices. The same section displays information related to a measurement performed by the measurement unit 100, or information obtained by the processing in the data processor 52, on the display device or print the information on a paper medium.

The control section 50 in the information processing unit 40 includes a processor, such as a central processing unit (CPU), and a storage medium, such as a memory. The same section functions as the main component for controlling the mass spectrometer 1. The control section 50 serves as a processing device winch performs analytical processing and other tasks performed by the data processor 52. The control section 50 performs various kinds of processing by loading a program from the storage section 43 or other locations into the memory and executing the program by the processor.

It should be noted that there is no specific limitation on the physical configuration (or other aspects) of the control section 50 as long as the processing by the control section 50 according to the present embodiment can be implemented.

The device controller 51 in the control section 50 controls the operation of each section of the measurement unit 100, based on the information concerning the analysis conditions based on an input from the input section 41, as well as the information stored in the storage section 43.

The data processor 52 in the control section 50 processes measurement data.

The first calculator 521 in the data processor 52 produces mass spectrum data from measurement data including the intensity of the detection signal of each ion detected by the detector section 30 and the time of flight of the ion. The first calculator 521 converts times of flight into m/z values based on previously obtained calibration data and produces mass spectrum data showing the intensity for each m/z value.

From the mass spectrum data, the first calculator 521 calculates a plurality of m/z values which respectively correspond to a plurality of peaks P in the mass spectrum MS10. The first calculator 521 can calculate an m/z value at the maximum intensity of each peak P. The first calculator 521 stores a set of data including the m/z values of the plurality of peaks P in the storage section 43 or other locations. This set of data is called the “peak data”. In the peak data, the m/z values may preferably be related to the corresponding detection intensities, although peak data which includes only the m/z values is also possible.

The second calculator 522 in the data processor 52 performs at least one of the previously described calculations (a) and (b), based on the plurality of m/z values calculated by the first calculator 521 and the kinds of ions that may be possibly produced by mass spectrometry. As for the kinds of ions, the second calculator 522 may be configured to allow the user to enter the information through the input section 41. As another possibility, the information concerning the atom or atom group to be added for the ionization may be stored in the storage section 43 beforehand, and the second calculator 522 may be configured to perform the aforementioned calculation for a type of ion that is easily generated in normal cases, such as a protonated ion, when no change of the condition is entered by the user. When the range of the m/z value of the first ion for the calculations (a) and (b) is set by the user's input or in the information stored in the storage section 43, the second calculator 522 selects a peak corresponding to the first ion from the set range of the m/z value.

The determiner 523 in the data processor 52 performs charge-number determination. The determiner 523 sets multiply charged ion peaks and singly charged ion peaks in the mass spectrum MS10, based on whether or not a peak corresponding to the m/z value of the second ion calculated by the second calculator 522 is present in the mass spectrum MS10. By referring to the calculated m/z value of the second ion and the peak data, the determiner 523 can determine whether or not a peak corresponding to the m/z value of the second ion is present in the mass spectrum MS10.

The similarity calculator 524 in the data processor 52 calculates a degree of similarity between the set of the plurality of m/z values included in the peak data and the set of the plurality of m/z values of the molecules contained in each microorganism included in the microorganism database 430. When calculating the degree of similarity, the similarity calculator 524 excludes the m/z values and/or detection intensities corresponding to the multiply charged ion peaks from the peak data.

For each microorganism included in the microorganism database 430, the similarity calculator 524 adds a predetermined value to the degree of similarity if an m/z value in the peak data is included within an allowable range of the variation in m/z value from the m/z value of an ion of a molecule contained in the microorganism, where the allowable range is specified based on the accuracy of the mass spectrometry. The similarity calculator 524 tests all m/z values corresponding to one microorganism in the microorganism database 430 and performs the addition of the degree of similarity when an m/z value in the peak data is included within the allowable range. As for the “predetermined value”, a different value may be set for each ion in the microorganism database 430 according to the frequency of the detection of the ion for each kind of microorganism (or other criteria). The similarity calculator 524 stores, in the storage section 43 (or other locations), the degree of similarity calculated for each microorganism included in the microorganism database 430.

There is no specific limitation on the definition of the degree of similarity and the method for calculating the degree of similarity. For example, when the information concerning the detection intensity is included in both the peak data and the microorganism database, the degree of similarity may be set based on how close to each other the values of the detection intensities are.

The identifier 525 identifies the microorganism contained in the sample based on the degree of similarity calculated by the similarity calculator 524. The identifier 525 identifies the microorganism having the highest degree of similarity as the microorganism contained in the sample.

The output controller 53 operates the output section 44 to output information obtained by the processing by the data processor 52, or other kinds of information. For example, the output controller 53 can display, on the display device, information concerning the analysis conditions of the mass spectrometry, or information concerning the microorganism identified by the identifier 525. The output controller 53 can also display, on the display device, a list on which microorganisms that may possibly be contained in the sample are shown in order of the degree of similarity.

(Process Steps of Method for Analyzing Data Acquired by MALDI Mass Spectrometry)

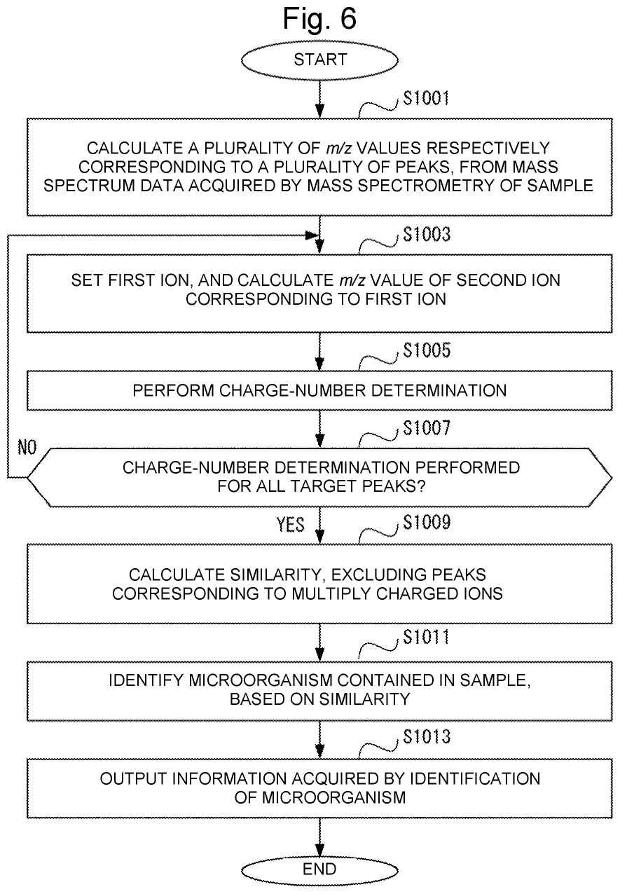

FIG. 6 is a flowchart showing the process steps of a method for analyzing data acquired by MALDI mass spectrometry according to the present embodiment. The example described in FIG. 6 is also concerned with the case of identifying a microorganism, although the present embodiment is not limited to this case. In Step S1001, the first calculator 521 calculates a plurality of m/z values which respectively correspond to a plurality of peaks P, from mass spectrum data acquired by a mass spectrometric analysis of a sample. After Step S1001 has been completed, Step S1003 is initiated.

In Step S1003, the second calculator 522 sets the first ion and calculates the m/z value of the second ion corresponding to the first ion. This calculation corresponds to the previously described calculations (a) and (b). After Step S1003 has been completed, Step S1005 is initiated. In Step S1005, the determiner 523 performs charge-number determination. After Step S1005 has been completed, Step S1007 is initiated.

In Step S1007, the data processor 52 determines whether or not the charge-number determination has been performed for all target peaks P. When the charge-number determination for all target peaks P has been completed, the control section 50 concludes that the determination result in Step S1007 is positive, and Step S1009 is initiated. If there is a target peak P for which the charge-number determination has not been performed yet, the control section 50 concludes that the determination result in Step S1007 is negative, and Step S1003 is initiated.

In Step S1009, the similarity calculator 524 performs the calculation of the degree of similarity, excluding the peaks corresponding to the multiply charged ions. After Step S1009 has been completed, Step S1011 is initiated. In Step S1011, the identifier 525 identifies the microorganism contained in the sample, based on the degree of similarity. After Step S1011 has been completed, Step S1013 is initiated.

In Step S1013, the output controller 53 outputs information acquired through the microorganism identification. After Step S1013 has been completed, the entire processing comes to an end.

The following modifications also fall within the scope of the present invention and can be combined with the previously described embodiment. In the following modified examples, the same reference sign as used in the previously described embodiment is used to refer to a component (or the like) which shows a similar structure or function to the previously described embodiment, and its description will be appropriately omitted.

### First Modified Example

In the previously described embodiment, the determiner 523 may be configured to perform the charge-number determination on a peak for which the number of charges has not been determined yet, based further on the intensity of at least one multiply charged ion peak which has been determined to be a peak corresponding to a multiply charged ion by the charge-number determination in the mass spectrum.

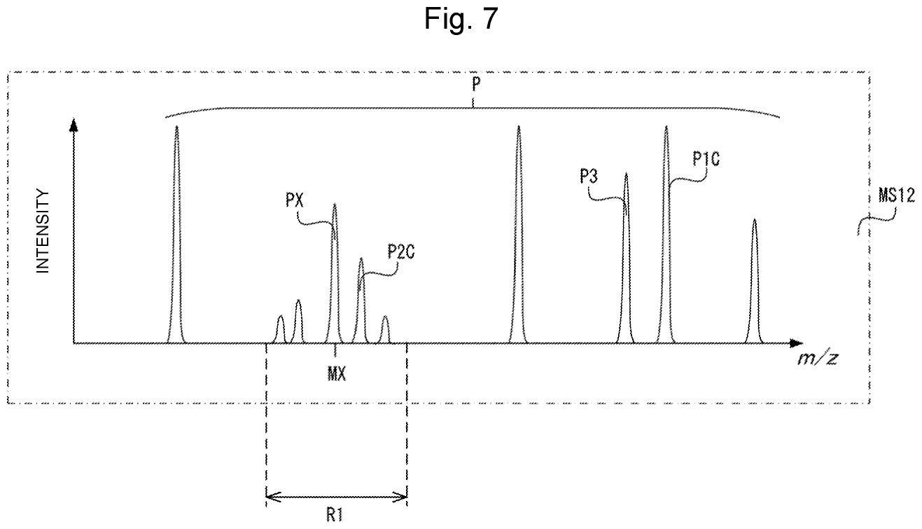

FIG. 7 is a conceptual diagram for explaining the method for the charge-number determination according to the present modified example. In the mass spectrum MS12 of a sample, the peak P3 is assumed to be a peak corresponding to the first ion which is singly charged, and the m/z value MX of the peak PX is included within the first range TL1 based on the m/z value of the second ion which is a doubly charged ion corresponding to the first ion.

In this case, there is also the possibility that the peak PX is a singly charged ion having an m/z value included within the first range TIL. For example, in the case of identifying a microorganism, if the microorganism contains a ribosomal protein whose molecular weight is roughly two times that of another ribosomal protein, it may be difficult to distinguish between the doubly charged ion of the former protein and the singly charged ion of the latter protein based on their m/z values.

In the present modified example, the determiner 523 performs the charge-number determination based further on the ratio between the detection intensity of at least one peak concluded to be a peak corresponding to a multiply charged ion by the charge-number determination, and the detection intensity of a peak of a singly charged ion corresponding to the at least one peak.

For a peak included within a range R1 including the m/z value MX of the peak PX, the determiner 523 extracts a peak P2C which has been determined to be a doubly charged ion by the charge-number determination. The determiner 523 calculates the ratio of the detection intensity of the singly charged ion P1C corresponding to the peak P2C, to the detection intensity of the peak P2C. This ratio is hereinafter called the “reference ratio”. The determiner 523 also calculates the ratio of the detection intensity of the peak P3 of the singly charged ion corresponding to the peak PX, to the detection intensity of the peak PX which is the target of the charge-number determination. This ratio is hereinafter called the “target ratio”. If the difference between the reference and target ratios is larger than a predetermined value, it is concluded that the peak PX is not a doubly charged ion, or that the peak PX is a singly charged ion. This predetermined value can be appropriately selected, for example from a range of 0.2-0.5, inclusive. There is no specific limitation on the range R1, for example, it may be a range having a width of m/z 100 to 1000, inclusive, centered on the m/z value MX of the peak PX. The range may also be the entire mass spectrum MS12.

It is also possible to perform the charge-number determination using the ratio of the detection intensity of an ion having the number of charges equal to or greater than two, to the detection intensity of a singly charged ion. The reference ratio may be a mean value, e.g., an arithmetic mean, of a plurality of ratios calculated for a plurality of pairs of ions. There is no specific limitation on the method of the comparison between the target and reference ratios as long as the method uses the target and reference ratios as a basis for the charge-number determination.

### Second Modified Example

The second modified example is similar to the first modified example in that the charge-number determination on a peak for which the number of charges has not been determined yet is performed based further on the intensity of at least one multiply charged ion peak in a mass spectrum. A difference from the first modified example exists in that the determiner 523 in the second modified example performs the charge-number determination based on the detection intensity of the multiply charged ion, rather than the ratio of the detection intensity.

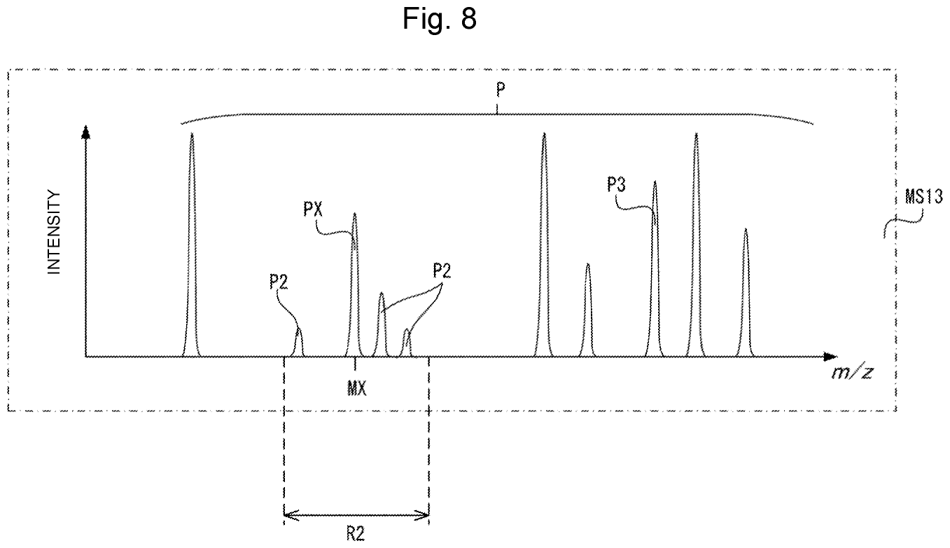

FIG. 8 is a conceptual diagram for explaining the method for the charge-number determination according to the present modified example. In the mass spectrum MS13 of a sample, the peak P3 is assumed to be a peak corresponding to the first ion which is singly charged, and the m/z value MX of the peak PX is included within the first range TL1 based on the m/z value of the second ion which is a doubly charged ion corresponding to the first ion.

In the present modified example, the determiner 523 performs the charge-number determination based further on the detection intensity of at least one peak P2 concluded to be a peak corresponding to a multiply charged ion by the charge-number determination. The determiner 523 extracts, from a range R2, a plurality of peaks P2 each of which has been determined to be a doubly charged ion by the charge-number determination. The determiner 523 calculates a mean value. e.g., an arithmetic mean, of the detection intensities of the plurality of peaks P2. This mean value is hereinafter called the “reference value”. If the difference between the detection intensity of the peak PX and the reference value is larger than a predetermined value, the determiner 523 concludes that the peak PX is not doubly charged, or the peak is singly charged.

If there is only a single peak P2 extracted, the detection sensitivity of that single peak P2 can be used as the reference value. There is no specific limitation on the method (or the like) of the comparison between the detection intensity of the peak PX and the reference value as long as the method uses the detection intensity and the reference value as a basis for the charge-number determination.

### Third Modified Example

In the previously described embodiment, multiply charged ion peaks are excluded from the data analysis. However, it is possible to identify a microorganism based on a comparison between the m/z value of a multiply charged ion peak and that of a multiply charged ion of a molecule contained in a microorganism included in the microorganism database 430. Thus, multiply charged ion peaks may be used for various kinds of data analysis.

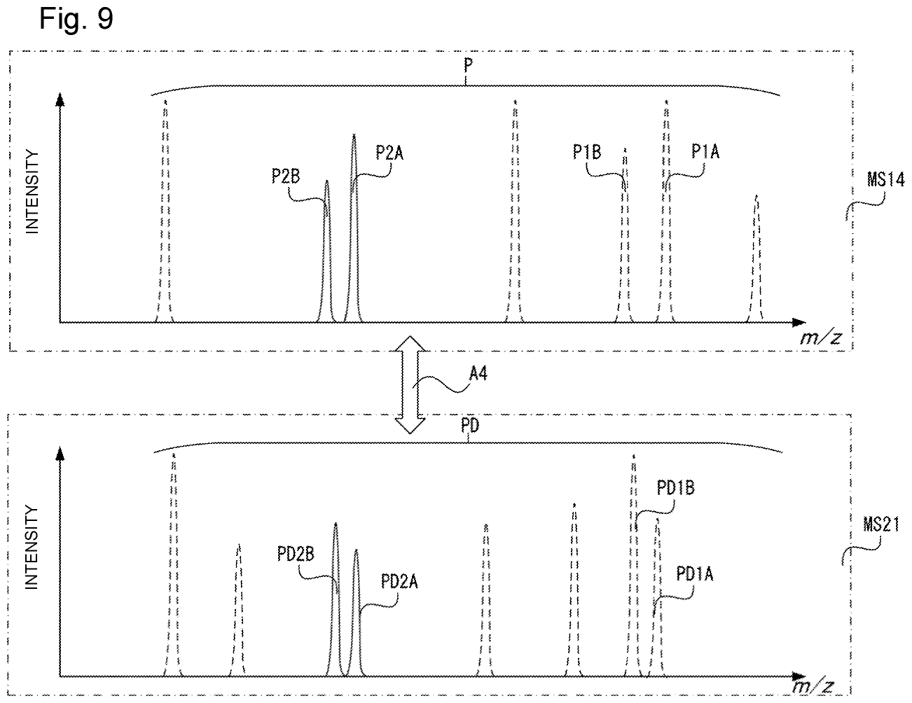

FIG. 9 is a conceptual diagram for explaining a method for analyzing data acquired by MALDI mass spectrometry according to the present modified example. The mass spectrum MS14 is a mass spectrum including the same set of peaks as the mass spectrum MS10, with the multiply charged ion peaks P2A and P2B indicated by solid lines, and singly charged ion peaks by broken lines. The singly charged ion peaks PIA and P1B correspond to the multiply charged ion peaks P2A and P2B, respectively. The mass spectrum MS21 is a mass spectrum schematically showing the ions of themolecules contained in a specific kind of microorganism. In the mass spectrum MS2L the peaks PD2A and PD2B which correspond to multiply charged ions are indicated by solid lines, while the peaks which correspond to singly charged ions are indicated by broken lines. The peaks PD1A and PD1B which correspond to the singly charged ions respectively correspond to the peaks PD2A and PD2B which correspond to the multiply charged ions. If the microorganism database 430 includes only the m/z values of singly charged ions, the similarity calculator 524 can use the previously shown equation (2) or other appropriate methods to calculate the m/z value of an ion corresponding to a singly charged ion and having the number of charges equal to or greater than two.

In the method according to the present modified example, the microorganism identification is performed based further on whether or not the multiply charged ion peaks P2A and P2B correspond to multiply charged ions of molecules contained in a microorganism, in addition to the previously described method in which singly charged ion peaks are used for the microorganism identification. In the example of FIG. 9, the similarity calculator 524 calculates the degree of similarity related to the multiply charged ion peaks indicated by solid lines in addition to the calculation of the degree of similarity related to the singly charged ion peaks indicated by broken lines. As for the algorithm for identifying a microorganism using the degree of similarity related to the multiply charged ion peaks, there is no specific limitation as long as the degree of similarity contributes to the identification of microorganisms. The degree of similarity related to the multiply charged ion peaks and that of the similarity related to the singly charged ion peaks may be added together to calculate an integrated degree of similarity. A reliability index may be calculated by using the degree of similarity related to the multiply charged ion peaks. In FIG. 9, the matching operation for evaluating the degree of similarity between the pattern of the peaks P in the mass spectrum MS14 and that of the peaks PD in the mass spectrum MS21 is schematically illustrated by the arrow A4.

As another example, the similarity calculator 524 determines whether or not both the singly charged ion peak, and the multiply charged ion peak which correspond to the aforementioned singly charged ion peak, correspond to the m/z value of the singly charged ion and that of the multiply charged ion of a molecule contained in a microorganism, respectively. When performing a data analysis, such as the microorganism identification, the data processor 52 can exclusively or preferentially use the singly charged ion peaks and the multiply charged ion peaks winch have been concluded to be peaks corresponding to those m/z values.

For example, in FIG. 9, with respect to the singly charged ions, suppose that the singly charged ion peak P1A corresponds to the peak PD1A, and the singly charged ion peak P1B corresponds to the peak PD1B. Furthermore, with respect to the doubly charged ions, suppose that the peak P2A corresponds to the peak PD2A, and the peak P2B corresponds to the peak PD2B. The similarity calculator 524 can be configured to add the degree of similarity only when the correspondence is thus established with respect to both the singly charged and doubly charged ions. As another possibility, when the correspondence is established with respect to both the singly charged and doubly charged ions, the similarity calculator 524 may increase the contribution to the degree of similarity by an appropriate method, such as the application of a larger weight to the degree of similarity than in the case where the correspondence is established with respect to only the singly charged ions.

### Fourth Modified Example

A program for realizing the information-processing functions of the mass spectrometer 1 can be recorded on a computer-readable record medium, and a program concerning the control of the previously described processing by the data processor 52 and the processing related to that processing, recorded on the same record medium, can be loaded onto a computer system and be executed. The “computer system” in the present context should be interpreted as including an OS (operating system) and peripheral hardware devices. The “computer-readable record medium” means a portable record medium, such as a flexible disk, magnetooptical disk, optical disk or memory card, as well as a storage device, such as a hard disk drive or solid-state drive (SSD) built in the computer system. Furthermore, the “computer-readable record medium” may include a type of medium which dynamically holds a program for a short period of time, such as a communication line in the case of transmitting the program through the Internet or similar networks, or through telephone lines or similar lines, or a type of medium which holds a program for a certain period of time, such as a volatile memory in a computer system acting as a server or client when transmitting the program. The aforementioned program may be a program for partially realizing the aforementioned functions, or it also may be a program for realizing the aforementioned functions by being combined with another program already recorded on the computer system.

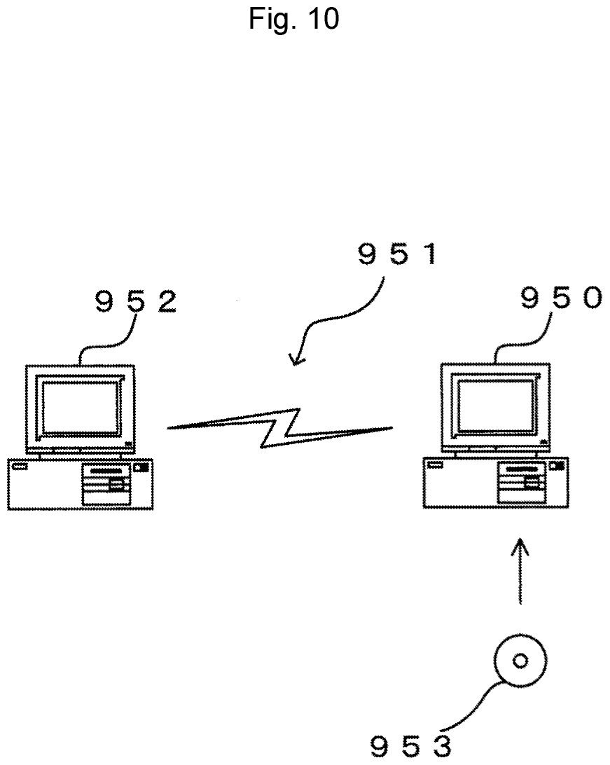

When applied to a personal computer (which is hereinafter abbreviated as “PC”), the program concerning the previously described control can be provided via a CD-ROM, DVD-ROM or similar record medium, or via data signals transmitted through the Internet or similar networks. FIG. 10 is a diagram showing these forms of provision. A PC 950 is provided with the program via a CD-ROM 953. The PC 950 has the function of connecting to a communication line 951. The computer 952 is a server computer offering the program. It has a hard disk or similar record medium on which the program is stored. The communication line 951 may be a public communication line, such as the Internet or PC communications, or a dedicated communication line. The computer 952 reads the program by means of the hard disk and transfers it to the PC 950 through the communication line 951. In other words, a carrier wave carrying the program in the form of data signals is transmitted through the communication line 951. Thus, the program can be supplied in various forms of computer-readable computer program products, such as record media or carrier waves.

(Modes)

A person skilled in the art can understand that the previously described illustrative embodiments or their modifications are specific examples of the following modes of the present invention.

(Clause 1)

A method for analyzing mass spectrum data acquired by matrix assisted laser desorption/ionization (MALDI) mass spectrometry according to one mode includes:
calculating a plurality of m/z values each of which corresponds to each of a plurality of peaks in a mass spectrum, from data corresponding to the mass spectrum acquired by a mass spectrometric analysis including MALDI performed on a sample, and
performing at least one of two calculations (a) and (b), based on the plurality of m/values and information on kinds of ions having a possibility of being generated from the sample in the mass spectrometric analysis, where
   the calculation (a) includes assuming that a plurality of ions each of which corresponds to each of the plurality of peaks are first ions that are singly charged ions, and calculating m/z values of second ions respectively corresponding to the first ions and being multiply charged ions, and
   the calculation (b) includes assuming that a plurality of ions each of which corresponds to each of the plurality of peaks are first ions that are multiply charged ions, and calculating m/z values of second ions respectively corresponding to the first ions and being singly charged ions.

By this method, a correct data analysis can be performed even when an ion having the number of charges equal to or greater than two has been generated by MALDI.

(Clause 2)

The method for analyzing data acquired by MALDI mass spectrometry according to another mode is one form of the method for analyzing data acquired by MALDI mass spectrometry according to the mode of Clause 1 and further includes making a determination, based on whether or not a peak corresponding to the m/z value of the second ion is detected in the mass spectrum, as to whether or not the first ion or an ion corresponding to the detected peak is singly charged.

By this method, the number of charges of an ion corresponding to a peak shown in a mass spectrum can be efficiently estimated.

(Clause 3)

In the method for analyzing data acquired by MALDI mass spectrometry according to still another mode, which is one form of the method for analyzing data acquired by MALDI mass spectrometry according to the mode of Clause 2, the determination is made, in the mass spectrum, based further on the intensity of at least one peak concluded to be a peak corresponding to an ion having the number of charges equal to or greater than two by the determination.

By this method, the number of charges of an ion corresponding to a peak can be more correctly estimated based on the tendency of the intensities of the peaks in a mass spectrum.

(Clause 4)

In the method for analyzing data acquired by MALDI mass spectrometry according to still another mode, which is one form of the method for analyzing data acquired by MALDI mass spectrometry according to the mode of Clause 2 or 3, the determination is made, in the mass spectrum, based further on the ratio between the intensity of at least one peak concluded to be a peak corresponding to an ion having the number of charges equal to or greater than two by the determination and the intensity of the peak of a singly charged ion corresponding to the at least one peak.

By this method, the number of charges of an ion corresponding to a peak can be more correctly estimated based on the tendency of the ratio between the intensities of the peaks corresponding to ions having different number of charges in a mass spectrum.

(Clause 5)

The method for analyzing data acquired by MALDI mass spectrometry according to still another mode is one form of the method for analyzing data acquired by MALDI mass spectrometry according to the mode of one of Clauses 2-4 and further includes performing a data analysis exclusive of a multiply charged ion peak concluded to be a peak corresponding to an ion having the number of charges equal to or greater than two by the determination.

By this method, a correct data analysis can be performed even in the case of using a data-analyzing method which is premised on that a singly charged ion is generated by MALDI.

(Clause 6)

In the method for analyzing data acquired by MALDI mass spectrometry according to still another mode, which is one form of the method for analyzing data acquired by MALDI mass spectrometry according to the mode of Clause 5, the data analysis includes identifying a microorganism contained in the sample, based on whether or not a peak included in the mass spectrum exclusive of the multiply charged ion peak corresponds to a singly charged ion of a molecule present in the microorganism.

By this method, a correct identification can be performed even in the case of using a method for identifying a microorganism which is premised on that a singly charged ion is generated by MALDI, such as the matching of the peak pattern of mass spectra.

(Clause 7)

The method for analyzing data acquired by MALDI mass spectrometry according to still another mode is one form of the method for analyzing data acquired by MALDI mass spectrometry according to the mode of one of Clauses 2-4 and further includes identifying a microorganism contained in the sample, based on whether or not a peak concluded to be a peak corresponding to a singly charged ion by the determination corresponds to a singly charged ion of a molecule present in the microorganism, and based also on whether or not a peak concluded to be a peak corresponding to an ion having the number of charges equal to or greater than two by the determination corresponds to an ion having the number of charges equal to or greater than two of the molecule present in the microorganism.

By this method, a more correct identification of a microorganism can be performed based on the correspondence of the singly charged ions and that of the doubly charged ions.

(Clause 8)

In the method for analyzing data acquired by MALDI mass spectrometry according to still another mode, which is one form of the method for analyzing data acquired by MALDI mass spectrometry according to the mode of Clause 6 or 7, the molecule is at least one of ribosomal proteins, DNA-binding proteins and chaperonin proteins.

These molecules are easily detected in mass spectra and thereby enable an even more correct identification of microorganisms.

(Clause 9)

A data processing device according to one mode includes:
a first calculator configured to calculate a plurality of m/z values each of which corresponds to each of a plurality of peaks in a mass spectrum, from data corresponding to the mass spectrum acquired by a mass spectrometric analysis including matrix assisted laser desorption/ionization (MALDI) performed on a sample; and
a second calculator configured to perform at least one of two calculations (a) and (b), based on the plurality of m/z values and information on kinds of ions having a possibility of being generated from the sample in the mass spectrometric analysis, where
   the calculation (a) includes assuming that a plurality of ions each of which corresponds to each of the plurality of peaks are first ions that are singly charged ions, and calculating m/z values of second ions respectively corresponding to the first ions and being multiply charged ions, and
   the calculation (b) includes assuming that a plurality of ions each of which corresponds to each of the plurality of peaks are first ions that are multiply charged ions, and calculating m/z values of second ions respectively corresponding to the first ions and being singly charged ions.

By this method, a correct data analysis can be performed even when an ion having the number of charges equal to or greater than two has been generated by MALDI.

(Clause 10)

A mass spectrometer according to one mode includes:
a data processing device according to Clause 9; and
an ionizer section for matrix assisted laser desorption ionization (MALDI).

By this method, a correct data analysis can be performed even when an ion having the number of charges equal to or greater than two has been generated by MALDI.

(Clause 11)

A data-analyzing program according to one mode is a program for making a computer perform:
a first calculation process which includes calculating a plurality of m/z values each of which corresponds to each of a plurality of peaks in a mass spectrum, from data corresponding to the mass spectrum acquired by a mass spectrometric analysis including matrix assisted laser desorption/ionization (MALDI) performed on a sample (this process corresponds to Step S1001 in the flowchart of FIG. 6); and
a second calculation process which includes performing at least one of two calculations (a) and (b), based on the plurality of m/z values and information on kinds of ions having a possibility of being generated from the sample in the mass spectrometric analysis, where
   the calculation (a) includes assuming that a plurality of ions each of which corresponds to each of the plurality of peaks are first ions that are singly charged ions, and calculating m/z values of second ions respectively corresponding to the first ions and being multiply charged ions, and
   the calculation (b) includes assuming that a plurality of ions each of which corresponds to each of the plurality of peaks are first ions that are multiply charged ions, and calculating m/z values of second ions respectively corresponding to the first ions and being singly charged ions (this process corresponds to Step S1003).

By this method, a correct data analysis can be performed even when an ion having the number of charges equal to or greater than two has been generated by MALDI.

The present invention is not limited to the contents of the previously described embodiment. Other modes which can be thought of within the scope of the technical idea of the present invention will also be included within the scope of the present invention.

Example

Hereinafter described is an example according to the present embodiment. It should be noted that the following example is not intended to limit the present invention.

In the present example, ions originating from Cutibacterium acnes (C. acnes JCM 18907) ionized by MALDI were subjected to a time-of-flight mass spectrometric analysis, and the acquired mass spectrum was analyzed.

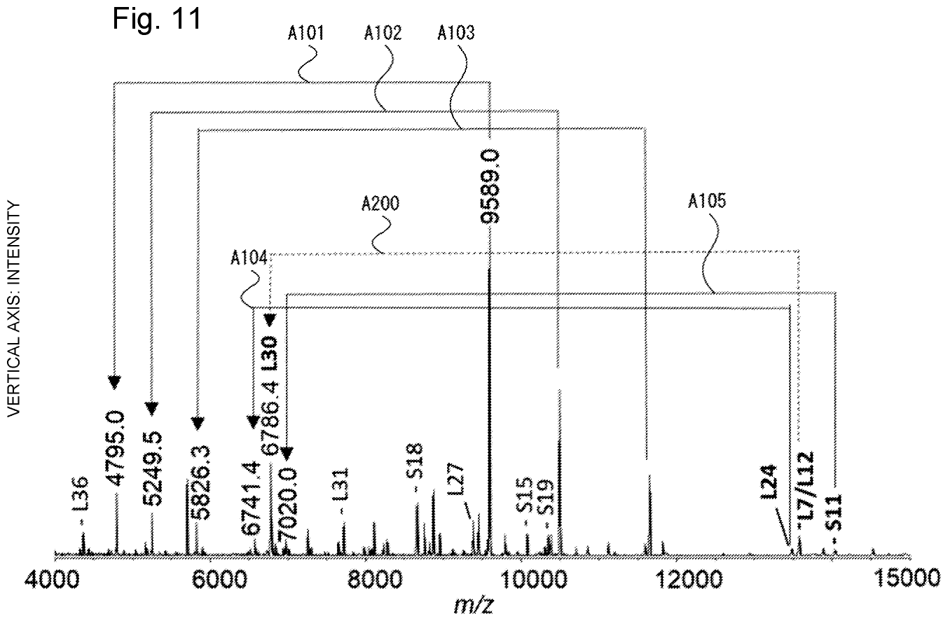

FIG. 11 shows the mass spectrum acquired in the present example. In this mass spectrum, the horizontal axis indicates the m/z values of the ions detected in the mass spectrometric analysis, and the vertical axis indicates the intensities of the detection signals of those ions. In FIG. 11, five examples of the pairs of the singly charged ion and the corresponding doubly charged ion are indicated by arrows A101, A102, A103, A04 and A105, respectively.

In the acquired mass spectrum, 434 peaks were detected within a range of m/z 4000-20000. For each peak within a range of m/z 8000-20000, a theoretical m/z value of the doubly charged ion was calculated on the assumption that the peak in question corresponds to a singly charged ion. On the other hand, 29 peaks within a range of m/z 4000-20000 were assigned to singly charged ions of ribosomal proteins. Within the same range, 62 peaks matched with the theoretical m/z values of the doubly charged ions, among which 15 peaks (which corresponded to ribosomal proteins S6, S7, S8, S11, S15, S16, S19, L6, L13, L15, L16, L17, L21, L23 and L24) were assigned to the doubly charged ions of the ribosomal proteins observed in the present mass spectrum. It can be said that these 15 ribosomal proteins whose correspondence with respect to the singly and doubly charged ions were established are ribosomal proteins of C. acnes JCM 18907 which were certainly observed.

Next, whether the peak at m/z 6786.4 was a singly or doubly charged ion was estimated using the peak intensity. The peak at m/z 6786.4 was possibly a singly charged ion of L30 or a doubly charged ion of L07/L12. However, in both cases, the difference was no greater than 200 ppm, so that it was difficult to achieve a highly reliable identification from the m/z values.

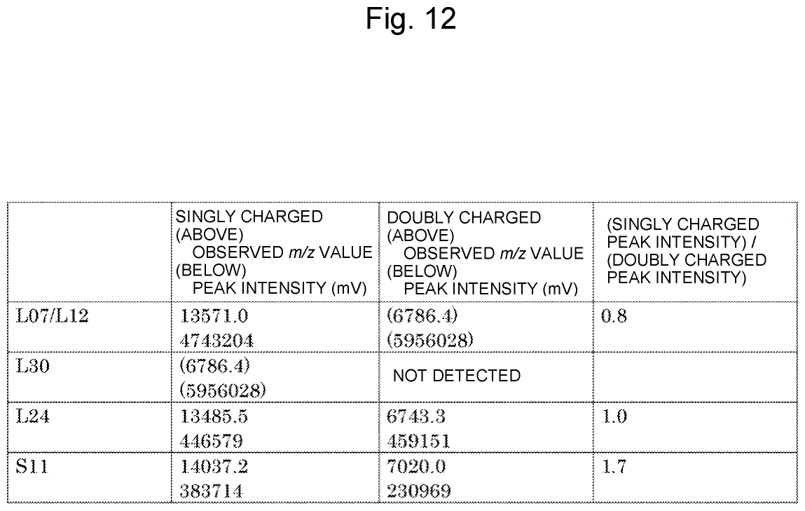

FIG. 12 is a table showing the m/z values (observed m/z values) and peak intensities of the peaks related to each other in the mass spectrum of C. acnes for the ribosomal proteins L07/L12, L30, L24 and S1. For the ribosomal proteins L07/L12, L24 and S1 for which both of the singly and doubly charged ions were possibly observed, the ratio of the peak intensity of the singly charged ion (“singly charged peak intensity”) to that of the doubly charged ion (“doubly charged peak intensity”) is also shown in the table. Since the peak at m/z 6786.4 may possibly correspond to the doubly charged ion of L07/L12 or the singly charged ion of L30, the numerical values are shown in parentheses in the corresponding positions in the table. Additionally, the broken arrow A200 in FIG. 11 schematically shows that the doubly charged ion peak of the L7/L 12 peak may possibly correspond to the peak at m/z 6786.4.

On the assumption that the peak at m/z 6786.4 corresponded to the doubly charged ion of L07/L12, the singly and doubly charged peak intensities of L07/L12 were compared. The result was (singly charged peak intensity)/(doubly charged peak intensity)=4743204/5956028=0.8. In the vicinity of the peak at m/z 6786.4, a peak corresponding to the doubly charged ion of L24 was observed at m/z 6471.4 (arrow A104). The singly and doubly charged peak intensities of L24 were compared. The result was (singly charged peak intensity)/(doubly charged peak intensity)=446579/459151=1. Furthermore, a peak corresponding to the doubly charged ion of S11 was observed at m/z 7020.0 (arrow A105). The singly and doubly charged peak intensities of S11 were compared. The result was (singly charged peak intensity)/(doubly charged peak intensity)=383714/230969=1.7. Accordingly, it was predicted that a doubly charged ion observed around m/z 7000 should have a detection intensity comparable to or lower than that of the corresponding singly charged ion. From these results, it was inferred that the peak at m/z 6786.4 was not a peak corresponding to a doubly charged ion.

As another method, the peak intensity of the peak at m/z 6786.4 was compared to the peak intensity of a doubly charged ion observed around m/z 6790 to estimate whether the peak at m/z 6786.4 was a singly charged ion or doubly charged ion. FIG. 12 shows that the peak at m/z 6786.4 was observed with a high intensity that was roughly 10 to 30 times the peak intensities of the peaks corresponding to the doubly charged ions of L24 and S1. From this result, the peak at m/z 6786.4 was considered to have originated from a singly charged ion, not a doubly charged ion.

### REFERENCE SIGNS LIST

1 . . . Mass Spectrometer; 10 . . . Ionizer Section; 20 . . . Mass Separator Section; 30 . . . Detector Section; 40 . . . Information Processing Unit; 43 . . . Storage Section; 44 . . . Output Section; 50 . . . Control Section; 52 . . . Data Processor; 100 . . . Measurement Unit; 430 . . . Microorganism Database; 521 . . . First Calculator; 522 . . . Second Calculator; 523 . . . Determiner; 524 . . . Similarity Calculator; 525 . . . Identifier; MS10, MS11, MS12, MS13, MS14 . . . Mass Spectrum of Sample; MS21, MS22 . . . Mass Spectrum of Microorganism; P, P1A, P1B, P1C, P2, P2A, P2B, P3, PX . . . Peaks in Mass Spectrum of Sample; PD, PD1, PD1A, PD1B, PD2, PD2A, PD2B . . . Peaks Corresponding to Ions of Molecules Contained in Microorganism; R1, R2 . . . Range; S . . . Sample Ions; TL1 . . . First Range; TL2 . . . Second Range

1. A method for analyzing mass spectrum data acquired by matrix assisted laser desorption/ionization (MALDI) mass spectrometry, comprising:
calculating a plurality of m/z values each of which corresponds to each of a plurality of peaks in a mass spectrum, from data corresponding to the mass spectrum acquired by a mass spectrometric analysis including MALDI performed on a sample; and
performing at least one of two calculations (a) and (b), based on the plurality of m/z values and information on kinds of ions having a possibility of being generated from the sample in the mass spectrometric analysis, where
the calculation (a) includes assuming that a plurality of ions each of which corresponds to each of the plurality of peaks are first ions that are singly charged ions, and calculating m/z values of second ions respectively corresponding to the first ions and being multiply charged ions, and
the calculation (b) includes assuming that a plurality of ions each of which corresponds to each of the plurality of peaks are first ions that are multiply charged ions, and calculating m/z values of second ions respectively corresponding to the first ions and being singly charged ions.

2. The method for analyzing data acquired by MALDI mass spectrometry according to claim 1, further comprising making a determination, based on whether or not a peak corresponding to the m/z value of the second ion is detected in the mass spectrum, as to whether or not the first ion or an ion corresponding to the detected peak is singly charged.

3. The method for analyzing data acquired by MALDI mass spectrometry according to claim 2, wherein the determination is made, in the mass spectrum, based further on an intensity of at least one peak concluded to be a peak corresponding to an ion having a number of charges equal to or greater than two by the determination.

4. The method for analyzing data acquired by MALDI mass spectrometry according to claim 2, wherein the determination is made, in the mass spectrum, based further on a ratio between an intensity of at least one peak concluded to be a peak corresponding to an ion having a number of charges equal to or greater than two by the determination and an intensity of a peak of a singly charged ion corresponding to the at least one peak.

5. The method for analyzing data acquired by MALDI mass spectrometry according to claim 2, further comprising performing a data analysis exclusive of a multiply charged ion peak concluded to be a peak corresponding to an ion having a number of charges equal to or greater than two by the determination.

6. The method for analyzing data acquired by MALDI mass spectrometry according to claim 5, wherein the data analysis includes identifying a microorganism contained in the sample, based on whether or not a peak included in the mass spectrum exclusive of the multiply charged ion peak corresponds to a singly charged ion of a molecule present in the microorganism.

7. The method for analyzing data acquired by MALDI mass spectrometry according to claim 2, further comprising identifying a microorganism contained in the sample, based on whether or not a peak concluded to be a peak corresponding to a singly charged ion by the determination corresponds to a singly charged ion of a molecule present in the microorganism, and based also on whether or not a peak concluded to be a peak corresponding to an ion having a number of charges equal to or greater than two by the determination corresponds to an ion having a number of charges equal to or greater than two of the molecule present in the microorganism.

8. The method for analyzing data acquired by MALDI mass spectrometry according to claim 6, wherein the molecule is at least one of ribosomal proteins, DNA-binding proteins and chaperonin proteins.

9. A data processing device, comprising:
a first calculator configured to calculate a plurality of m/z values each of which correspond to each of a plurality of peaks in a mass spectrum, from data corresponding to the mass spectrum acquired by a mass spectrometric analysis including matrix assisted laser desorption/ionization (MALDI) performed on a sample; and
a second calculator configured to perform at least one of two calculations (a) and (b), based on the plurality of m/z values and information on kinds of ions having a possibility of being generated from the sample in the mass spectrometric analysis, where
the calculation (a) includes assuming that a plurality of ions each of which corresponds to each of the plurality of peaks are first ions that are singly charged ions, and calculating m/z values of second ions respectively corresponding to the first ions and being multiply charged ions, and
the calculation (b) includes assuming that a plurality of ions each of which corresponds to each of the plurality of peaks are first ions that are multiply charged ions, and calculating m/z values of second ions respectively corresponding to the first ions and being singly charged ions.

10. A mass spectrometer, comprising:
a data processing device according to claim 9; and
an ionizer section for matrix assisted laser desorption ionization (MALDI).

11. A non-transitory computer-readable medium storing a data-analyzing program for making a computer perform:
a first calculation process which includes calculating a plurality of m/z values each of which corresponds to each of a plurality of peaks in a mass spectrum, from data corresponding to the mass spectrum acquired by a mass spectrometric analysis including matrix assisted laser desorption/ionization (MALDI) performed on a sample; and
a second calculation process which includes performing at least one of two calculations (a) and (b), based on the plurality of m/z values and information on kinds of ions having a possibility of being generated from the sample in the mass spectrometric analysis, where
the calculation (a) includes assuming that a plurality of ions each of which corresponds to each of the plurality of peaks are first ions that are singly charged ions, and calculating m/z values of second ions respectively corresponding to the first ions and being multiply charged ions, and
the calculation (b) includes assuming that a plurality of ions each of which corresponds to each of the plurality of peaks are first ions that are multiply charged ions, and calculating m/z values of second ions respectively corresponding to the first ions and being singly charged ions.
